(19) United States
(12) Patent Application Publication
(10) Pub. No.: US 2005/0219652 A1
(43) Pub. Date: Oct. 6, 2005

(54) Method and system to correct right and left positions of scan area

(76) Inventor: Seong-kyoo Park, Suwon-si (KR)

Correspondence Address: STANZIONE & KIM, LLP, 1740 N STREET, N.W., FIRST FLOOR, WASHINGTON, DC, 20036, US

(21) Appl. No.: 11/029,402

(22) Filed: Jan. 6, 2005

(30) Foreign Application Priority Data
Jan. 9, 2004 (KR) 2004-1425

(51) Int. Cl. G06F 15/00; G06K 9/00; H04N 1/04

(52) U.S. Cl. 358/488; 358/1.18; 358/497

(57) ABSTRACT

A system to correct left and right positions of a scan area of a document when the document is displaced leftward or rightward in the course of correcting a skew incurred during a transfer of the document in a scanner including an automatic document feeder, the system including a skew amount detecting unit to detect a skew amount of the document, a displacement detecting unit to detect a leftward or rightward displacement of the document using the skew amount, and a correcting unit to correct the left and right positions of the scan area of the document using the leftward or rightward displacement detected.

### CROSS-REFERENCE TO RELATED APPLICATIONS

This application claims the priority of Korean Patent Application No. 2004-1425, filed on Jan. 9, 2004, in the Korean Intellectual Property Office, the disclosure of which is incorporated herein in its entirety and by reference.

### BACKGROUND OF THE INVENTION

1. Field of the Invention

The present general inventive concept relates to a method and system to correct left and right positions of a scan area, and more particularly, to a method and system, which can correct left and right positions of a scan area when a document is displaced leftward or rightward in the course of correcting a skew incurred during a transfer of the document in a scanner having an automatic document feeder.

2. Description of the Related Art

A skew may be incurred during a transfer of a document in a scanner having an automatic document feeder. Such a skew must be corrected to accurately scan an image. U.S. Pat. No. 5,452,374 discloses a method of correcting such a skew.

FIG. 1 is a flowchart illustrating a conventional method of correcting a skew.

Referring to FIG. 1, when a user issues a scanning command using a key provided on a scanner (S100), a central process unit (CPU) of the scanner determines a scanning area of a document (S102). Then, the document is transferred by a motor of the scanner (S104), and it is determined if the document is detected by a sensor of the scanner (S106). When the document is not detected, the document is continuously transferred. When the document is detected, a skew is corrected by applying resistance in a direction where the document is advanced (S108). Next, it is determined if the document reaches a scanning position (S110). When the document reaches the scanning position (S110), the document is scanned (S112). Then, it is determined if the scanning reaches a rear end of the document (S114), and, when the scanning reaches the rear end of the document, the scanning operation is ended.

FIGS. 2A and 2B are schematic views illustrating a phenomenon where the document is displaced leftward or rightward during the correction of the document skew.

Referring first to FIG. 2A, there is shown a case where a right end of a document 1 is transferred in advance of a left end of the document 1 with respect to a direction in which the document 1 is advanced. When the right end of the document 1 is transferred in advance of the left end of the document 1, the document 1 may be displaced leftward during the correction of the document skew. That is, the skew is corrected by allowing the left end of the document 1 to be transferred while keeping the right end of the document 1 from being transferred. However, this may cause the document 1 to be displaced leftward, as a result of which a scanned image may be sided rightward of the document 1.

Referring to FIG. 2B, there is shown a case where the left end of the document 1 is transferred in advance of the right end of the document 1 with respect to a direction in which the document 1 is advanced. When the left end of the document 1 is transferred in advance of the right end of the document 1, the document 1 may be displaced rightward during the correction of the document skew. That is, the skew is corrected by allowing the right end of the document 1 to be transferred while keeping the left end of the document 1 from being transferred. However, this may cause the document 1 to be displaced rightward, as a result of which the scanned image may be sided leftward of the document 1.

As described above, the document 1 may be erroneously displaced leftward or rightward during the skew correction of the document 1. As a result, there may be an error in the scanned image displaced leftward and rightward.

### SUMMARY OF THE INVENTION

The present general inventive concept provides a method and system to correct left and right positions of a scan area in proportion to a skew amount of a document, which is detected by a sensor, thereby providing an accurate scanned image.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of correcting left and right positions of a scan area of a document, the method comprising detecting a skew amount of a document, calculating left and right displacements of the document using the detected skew amount, and correcting the left and right positions of the scan area of the document using the left and right displacements.

The detecting of a skew amount may comprise detecting a first advanced distance of the document using a first sensor, detecting a second advanced distance of the document using a second sensor, and calculating the skew amount using a difference between the first and second advanced distances.

The first and second sensors may be vertically disposed with respect to a direction in which the document is advanced, and may be formed of photo sensors.

The first advanced distance may be an advanced distance detected at a left end of the document and the second advanced distance may be an advanced distance detected at a right end of the document.

The foregoing and/or other aspects and advantages of the present general inventive concept may also be achieved by providing a system to correct left and right positions of a scan area of a document, the system comprising a skew amount detecting unit to detect a skew amount of a document, a displacement detecting unit to detect a leftward or rightward displacement of the document using the skew amount, and a correcting unit to correct the left and right positions of the scan area of the document using the leftward or rightward displacement detected.

The skew amount detecting unit may comprise a first detector to detect a first advanced distance of the document using a first sensor; a second detector to detect a second advanced distance of the document using a second sensor; and a calculating unit to calculate the skew amount using a difference between the first and second advanced distances.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a prior method for correcting a skew;

FIG. 2A is a schematic view illustrating a case where a right end of a document is transferred in advance of a left end of the document;

FIG. 2B is a schematic view illustrating a case where a left end of a document is transferred in advance of a right end of the document;

FIG. 3 is a block diagram illustrating a system to correct left and right positions of a scan area according to an embodiment of the present general inventive concept;

FIG. 4 is a block diagram illustrating a multifunction printer with a scanning function, where a system and method according to another embodiment of the present general inventive concept are applied;

FIG. 5 is a flowchart illustrating a method of correcting left and right positions of a scan area according to another embodiment of the present general inventive concept; and

FIG. 6 is a flowchart illustrating a scanning method where a method of correcting left and right positions of a scan area according to another embodiment of the present general inventive concept is employed.

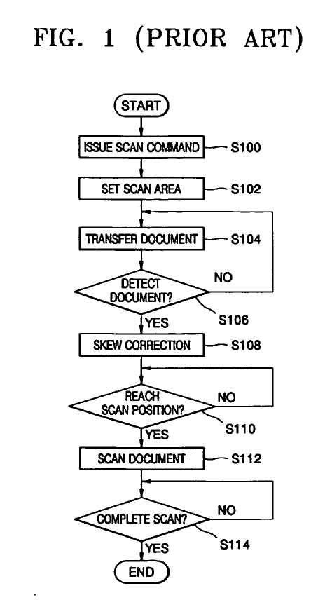

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

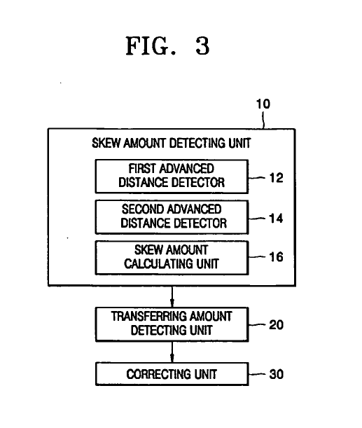

FIG. 3 is a block diagram illustrating a system to correct left and right positions of a scan area according to an embodiment of the present general inventive concept;

As shown in FIG. 3, a system to correct left and right positions of a scan area may comprise a skew amount detecting unit 10, a transferring amount detecting unit 20 and a correcting unit 30.

The skew amount detecting unit 10 is provided to obtain an amount of a skew of a document and may comprise a first advanced distance detector 12, a second advanced distance detector 14, and a skew amount calculating unit 16. The first advanced distance detector 12 can be formed of a first sensor to detect a first advanced distance of the document, the second advanced distance detector 14 can be formed of a second sensor to detect a second advanced distance of the document, and the skew amount calculating unit 16 can calculate a skew amount of the document using a difference between the first and second advanced distances of the document.

The transferring amount detecting unit 20 can calculate a displacement amount of the document leftward and rightward using the skew amount, and the correcting unit 30 can correct the left and right positions of the scan area of the document using the displacing amount of the document leftward and rightward. For example, when a document is displaced leftward, the scan area of the document can also be shifted leftward.

The first and second sensors may be photo sensors, and may be vertically disposed with respect to a direction in which the document is advanced.

The first advanced distance may be measured at a left side of the document while the second advanced distance may be measured at a right side of the document.

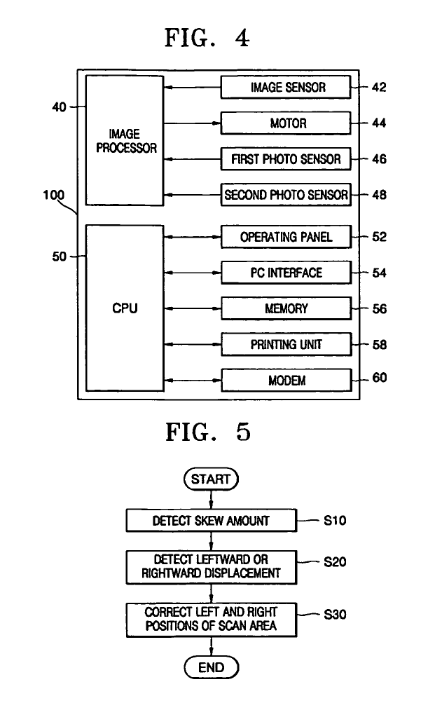

FIG. 4 is a block diagram illustrating a multifunction printer with a scanning function, where a system and method according to another embodiment of the present general inventive concept are applied. The multifunction printer may comprise a scanning function, a copying function, a printing function, and a facsimile function.

Referring to FIG. 4, a multifunction printer 100 having a scanning function may comprise a central process unit (CPU) 50, an image processor 40, an image sensor 42, a motor 44, a first photo sensor 46, a second photo sensor 48, an operating panel 52, a PC interface 54, a memory 56, a printing unit 58, and a modem 60.

The CPU 50 controls the overall operation of the multifunction printer 100. The image processor 40 can be coupled to the CPU 50 to convert an analog signal input from the image sensor 42 into a digital signal. The image sensor 42 is composed of a light source and a sensor to generate the analog signal corresponding to a document and transmits the analog signal to the image processor 40. The motor 44 can be controlled by the image processor 40 to advance the image sensor 42 or the document in a scanning direction. According to this embodiment of the present general inventive concept, the motor 44 is designed to advance the document in the scanning direction. The first and second photo sensors 46 and 48 can be vertically disposed with respect to the scanning direction, in which the document is advanced, to detect an advanced position of the document. The first photo sensor 46 can be used to detect an advanced distance measured at a left end of the document, and the second photo sensor 48 can be used to detect an advanced distance measured at a right end of the document.

The operating panel 52 may include a key input part and a display part. The key input part can transmit key data generated by a user's key operation to the CPU 50. The display part can be formed of a liquid crystal display to display a message transmitted from the CPU 50.

The PC interface 54 performs as an interface with a personal computer PC. The memory 56 stores data (i.e., scanned image data). The printing unit 58 prints data transmitted from the modem 60 or the data stored in the memory 56. The modem 60 can be controlled by the CPU 50 to modulate the digital signal transmitted from the CPU 50 into an analog signal and to demodulate an analog signal input from a public switched telephone network (PSTN) into a digital signal.

FIG. 5 is a flowchart illustrating a method of correcting left and right positions of a scan area according to another embodiment of the present general inventive concept. This embodiment of the present general inventive concept provides a method that can correct left and right positions of a scan area when a document is displaced leftward or rightward in the course of correcting a skew incurred during a transfer of the document in a scanner having an automatic document feeder.

Referring to FIG. 5, a skew amount of the document is first detected (S10). That is, a first advanced distance, i.e., an advanced distance measured at a left end of the document, is detected by a first sensor, and a second advanced distance, i.e., an advanced distance measured at a right end of the document, is detected by a second sensor. The skew amount of the document is calculated using a difference of the first and second advanced distances. Then, a leftward or rightward displacement of the document is detected using the skew amount (S20). Finally, the left and right positions of the scan area of the document are corrected using the leftward or rightward displacement (S30).

The first and second sensors may be photo sensors, and may be vertically disposed in a direction in which the document is advanced.

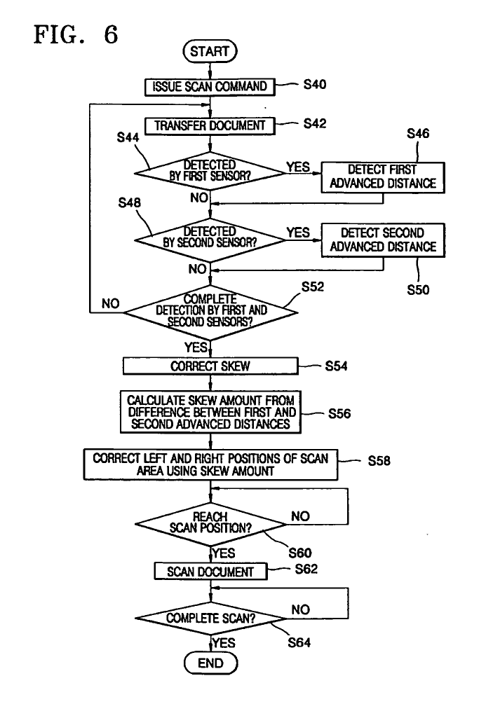

FIG. 6 is a flowchart illustrating a scanning method where a method of correcting left and right positions of a scan area according to another embodiment of the present general inventive concept is employed.

Referring to FIG. 6, when the user issues a scanning command using a key of an operating panel (S40), a motor is driven to transfer a document (S42). Then, it can be determined whether the document is detected by a first sensor (S44). When the document is detected by the first sensor, a first advanced distance from a predetermined start position to a detected position of the document can be detected and stored (S46). Next, it can be determined whether the document is detected by a second sensor (S48). When the document is detected by the second sensor, a second advanced distance from the predetermined start position to the detected position of the document is detected and stored (S50). The first advanced distance can be an advanced distance measured at a left end of the document, and the second advanced distance can be an advanced distance measured at a right end of the document.

Next, it can be determined whether the detection of the document by the first and second sensors is complete (S52). When it is not complete, the process returns to operation S42. When it is complete, the skew of the document can be corrected by applying resistance in the direction where the document is advanced (S54). A difference between the first and second advanced distances can be calculated, and the skew amount can be calculated based on the difference (S56). The leftward or rightward displacement of the document can be calculated using the calculated skew amount and the left and right positions of the scan area are corrected (S58).

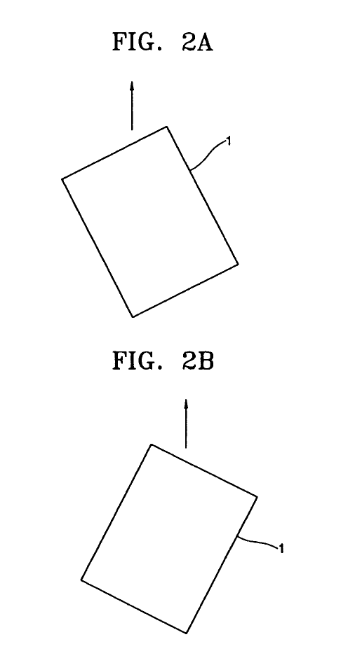

For example, as shown in FIG. 2A, when the right end 1 of the document is transferred in advance of the left end of the document, the document may be displaced leftward during the skew correction. That is, since the skew correction is realized by fixing the right end 1 of the document and transferring the left end of the document, the document may be displaced leftward. Therefore, the leftward displacement of the document is calculated considering that it is proportional to the skew amount. The scan area is displaced leftward using the leftward displacement.

Next, it can be determined whether the document reaches a scan position (S60). When the document reaches the scan position, the document can be scanned (S62). Then, it can be determined that whether the scan is realized up to a rear end of the document (S64). When the scan is realized up to the rear end of the document, the scanning operation ends.

According to the above-described embodiments of the present general inventive concept, it becomes possible to provide an accurate scan image to the user by correcting the left and right positions of the scan area according to the amount of the skew generated during the transfer of the document.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of correcting left and right positions of a scan area of a document when the document is displaced leftward or rightward in the course of correcting a skew incurred during a transfer of the document in a scanner including an automatic document feeder, the method comprising:
detecting a skew amount of a document;
calculating a left or right displacement of the document using the detected skew amount; and
correcting the left and right positions of the scan area of the document using the left or right displacement.

2. The method of claim 1, wherein the detecting of the skew amount comprises:
detecting a first advanced distance of the document using a first sensor;
detecting a second advanced distance of the document using a second sensor; and
calculating the skew amount using a difference between the first and second advanced distances.

3. The method of claim 2, wherein the first and second sensors are vertically disposed with respect to a direction in which the document is advanced.

4. The method of claim 2, wherein each of the first and second sensors is formed of a photo sensor.

5. The method of claim 2, wherein the first advanced distance is an advanced distance detected at a left end of the document and the second advanced distance is an advanced distance detected at a right end of the document.

6. A method of adjusting a document in a scanner having an automatic document feeder, when the document is skewed during feeding, the method comprising:
correcting a skew of a document; and
correcting a leftward or rightward displacement of the document resulting from the correcting of the skew.

7. The method of claim 6, wherein the correcting of the skew comprises:
detecting a skew amount; and
applying a resistance to correct the skew amount.

8. The method of claim 7, wherein the detecting of the skew amount comprises:
detecting a first advanced distance of the document;
detecting a second advanced distance of the document; and
calculating the skew amount using a difference between the first and second advanced distances.

9. The method of claim 8, wherein the first advanced distance is an advanced distance detected at a left end of the document and the second advanced distance is an advanced distance detected at a right end of the document.

10. The method of claim 7, wherein the correcting of the leftward or rightward displacement comprises:
calculating the leftward or rightward displacement of the document using the detected skew amount; and
correcting a left and right positions of a scan area of the document to compensate for the leftward or rightward displacement.

11. The method of claim 10, wherein the correcting of the left and right positions of the scan area of the document comprises:
shifting the left and right positions of the scan area of the document to the left when the leftward or rightward displacement is calculated to be a leftward displacement; and shifting the left and right positions of the scan area of the document to the right when the leftward or rightward displacement is calculated to be a rightward displacement.

12. A system to correct left and right positions of a scan area of a document when the document is displaced leftward or rightward in the course of correcting a skew incurred during a transfer of the document in a scanner including an automatic document feeder, the system comprising:
a skew amount detecting unit to detect a skew amount of the document;
a displacement detecting unit to detect a leftward or rightward displacement of the document using the skew amount; and
a correcting unit to correct the left and right positions of the scan area of the document using the leftward or rightward displacement detected.

13. The system of claim 12, wherein the skew amount detecting unit comprises:
a first detector to detect a first advanced distance of the document using a first sensor;
a second detector to detect a second advanced distance of the document using a second sensor; and
a calculating unit to calculate the skew amount using a difference between the first and second advanced distances.

14. The system of claim 13, wherein the first and second sensors are vertically disposed with respect to a direction in which the document is advanced.

15. The system of claim 13, wherein each of the first and second sensors is formed of a photo sensor.

16. The system of claim 13, wherein the first advanced distance is an advanced distance detected at a left end of the document and the second advanced distance is an advanced distance detected at a right end of the document.

17. A multifunction printer with a scanning function in which a motor advances a document to an image sensor and the image sensor has a scan area with left and right boundries, the multifunction printer comprising:
a skew amount detecting unit to detect a skew amount of the document;
a displacement detecting unit to detect a leftward or rightward displacement of the document using the skew amount; and
a correction unit to shift the left and right boundaries of the scan area to compensate for the leftward or rightward displacement.

18. The multifunction printer of claim 17, wherein the skew amount detecting unit comprises:
a first detector to detect a first advanced distance of the document using a first sensor;
a second detector to detect a second advanced distance of the document using a second sensor; and
a calculating unit to calculate the skew amount using a difference between the first and second advanced distances.

19. A document position correcting unit to correct a skew amount of a document positioned at a document reading position, comprising:
a skew amount detecting unit to detect a skew amount of a document placed at a position to be read;
a transfer amount detecting unit to calculate a displacement amount of the document with respect to the document reading position by using the skew amount;
a correction unit to correct the displacement amount by shifting boundaries of the document reading position to compensate for the displacement amount.

20. The document position correcting unit of claim 19, wherein the skew amount detecting unit comprises:
a first detector to detect a first advanced distance of the document using a first sensor;
a second detector to detect a second advanced distance of the document using a second sensor; and
a calculating unit to calculate the skew amount using a difference between the first and second advanced distances.
